(19) United States
(12) Patent Application Publication
(10) Pub. No.: US 2002/0107758 A1
(43) Pub. Date: Aug. 8, 2002

(54) Communication system, communication information processing unit, information terminal unit, product recommendation method, and computer program

(75) Inventors: Tetsuo Takakura, Tokyo (JP); Masaomi Sato, Tokyo (JP)

Correspondence Address: LOWE HAUPTMAN GOPSTEIN, GILMAN AND BERNER LLP, SUITE 310, 1700 DIAGONAL ROAD, ALEXANDRIA, VA, 22314

(73) Assignee: ISAO Corporation

(21) Appl. No.: 10/062,634

(22) Filed: Feb. 5, 2002

(30) Foreign Application Priority Data
Feb. 5, 2001 (JP) 2001-28882

(51) Int. Cl. G06F 17/60

(52) U.S. Cl. 705/26

(57) ABSTRACT

A system according to the present invention has a plurality of client units connected to a server unit 100 via a network, to enable users of the client units to communicate with each other using the client units. The server unit stores product information according to a product that an online shopping site sells. The server unit receives a recommendation request for a first user to recommend the desired product, and notifies a second user about a message that the first user recommends the product to the second user, based on the received recommendation request.

### FIELD OF THE INVENTION

The present invention relates to a communication system, a communication information processing unit, an information terminal unit, a product recommendation method, and a computer program.

### BACKGROUND OF THE INVENTION

Conventionally, in the marketing of products at online shopping sites on the Internet, there has been service that the online shopping site provides a certain kickback to a purchaser of a product when the purchaser recommends this product to other person and when this person purchases the recommended product. Under this service, a person who recommends a product has a possibility of obtaining larger kickback if this person recommends the product to as many persons as possible.

However, in general, a recommender prepares a recommendation statement and sends this message to other persons by electronic mail or the like. Therefore, this method has a basic structural problem in the system that it is very troublesome for the recommender to send recommendation mails to many persons.

Further, there has been disclosed a communication system that comprehensively provides real-time messages, electronic mails, electronic bulletin boards, and chats to users, in Japanese Patent Application Laid-open Publication No. 2000-381028 by the applicant of the present invention.

A user of such a comprehensive communication system can transmit a product recommendation statement to many persons relatively efficiently when the user makes full utilization of each communication unit that is provided by the system. However, it is also troublesome for the user to operate each communication unit, and the procedure of extracting all relevant persons and sending mails to them is also complicated.

Further, advertising through mouth to ears has large effect. Particularly, when a well-known individual utters a word about a product, this might have possibility of deciding popularity of the product. However, there is a limit to face-to-face oral advertising, and this method has a limitation in the spreading of information to individuals.

As explained above, conventional systems have many problems. As a result, these systems are not convenient for users who recommend products, and also for shopping malls that sell products. The advertising efficiency of these systems has not been satisfactory either.

The problems that the conventional techniques and invention have tried to solve are applied not only to the online shopping system on the Internet, but also similarly applied to all systems that recommend products to be transacted online such as online shopping on a mobile communication network using portable telephones.

### SUMMARY OF THE INVENTION

It is an object of the present invention to provide a communication system, a communication information processing unit, an information terminal unit, a product recommendation method, and a program that can efficiently transmit a product recommendation statement to many persons based on a simple operation. With this arrangement, an individual can easily work as an advertising medium and as an individual shop, thereby to maximize the power of individual.

In order to achieve the above object, according to a first aspect of the present invention, there is provided a communication system which uses a plurality of information terminal units that are connected to a communication information processing unit via a network, and in which users of the information terminal units communicate with each other, the communication system comprising, a product information storing unit which stores product information relevant to a product that an online shopping site sells, a recommendation request receiving unit which receives a recommendation request in which a first user recommends the desired product, and a recommending unit which notifies a second user that the first user recommends the product to the second user, based on the recommendation request that has been received by the recommendation request receiving unit.

According to this communication system, this system stores product information relevant to a product (the “product” includes a product that is relevant to service like a financial product, for example) that an online shopping site sells. The system receives a recommendation request in which a first user recommends the desired product, and notifies a second user that the first user recommends the product to the second user, based on the received recommendation request. Therefore, a server unit can efficiently recommend a registered product to a user. Further, when a user has purchased the product, the user can receive kickback from the online shopping site. The user can efficiently transmit a product recommendation statement to many persons based on a simple operation. Therefore, an individual can easily work as an advertising medium, and also as an individual shop. This can maximize the power of the individual. Further, the online shopping can efficiently advertise the own product to users of the communication system.

Further, according to a second aspect of the invention, there is provided a communication information processing unit which is connected to a plurality of information terminal units via a network, and which structures a communication system in which users of the information terminal units communicate with each other, the communication information processing unit comprising, a product information storing unit which stores product information relevant to a product that an online shopping site sells, a recommendation request receiving unit which receives a recommendation request in which a first user recommends the desired product to a second user, and a recommending unit which notifies the second user that the first user recommends the product to the second user, based on the recommendation request that has been received by the recommendation request receiving unit.

According to this communication information processing unit, this unit stores product information relevant to a product that an online shopping site sells. The unit receives a recommendation request in which a first user recommends the desired product, and notifies a second user that the first user recommends the product to the second user, based on the received recommendation request. Therefore, a server unit can efficiently recommend a registered product to a user. Further, when the second user has purchased the product, the first user can receive kickback from the online shopping site. The user can efficiently transmit a product recommendation statement to many persons based on a simple operation. Therefore, an individual can easily work as an advertising medium, and also as an individual shop. This can maximize the power of the individual. Further, the online shopping can efficiently advertise the own product to users of the communication system.

Further, a third aspect of the invention provides the communication information processing unit according to the second aspect, further comprising, a relevant-person storing unit which stores information on other users who have a predetermined relationship with the user, wherein the second user is a user who has been registered in the relevant-person storing unit as a person having a relationship with the first user.

This more specifically shows one example of the second user. According to this communication information processing unit, this unit stores information on other users who have a predetermined relationship with the user. The second user is a user who has been registered as a person having a relationship with the first user. Therefore, when a user has a friend list that is provided by the communication system, the user can make recommendation to users who are on this list.

Further, according to a fourth aspect of the invention, there is provided the communication information processing unit of the second or third aspect, wherein the product information includes product attribute information that is relevant to attributes of the product, the communication information processing unit further comprises, a user attribute storing unit which stores user attribute information that is relevant to attributes of the user, and a user extracting unit which extracts the user who has the user attribute information relevant to the product attribute information of the product that has been recommended by the first user in the recommendation request, wherein the second user is the user who has been extracted by the user extracting unit.

This more specifically shows one example of the second user. According to this communication information processing unit, the product information includes product attribute information that is relevant to attributes of the product. The communication information processing unit further stores user attribute information that is relevant to attributes of the user, and extracts the user who has the user attribute information relevant to the product attribute information of the product that has been recommended by the first user in the recommendation request. The second user is the user who has been extracted. Therefore, it is possible to extract users who are interested in the product, and make recommendation to these extracted users. Consequently, it is possible to transmit information to the users that is useful for them. Further, it is also possible to increase the product advertising efficiency.

Further, according to a fifth aspect of the invention, there is provided the communication information processing unit in any one of the second to fourth aspects, wherein the user attribute information is at least one of user's information on gender, occupation, constellation, age, blood type, date of birth, hobby, special ability, address, resident area, interested genre, interested products, and signs of the zodiac.

This more specifically shows one example of the user attribute information. According to this communication information processing unit, the user attribute information is at least one of user s information on gender, occupation, constellation, age, blood type, date of birth, hobby, special ability, address, resident area, interested genre, interested products, and signs of the zodiac. Therefore, it is possible to efficiently recommend a product that has product attributes relevant to these attributes.

Further, according to a sixth aspect of the invention, there is provided the communication information processing unit in any one of the second to fifth aspects, further comprising, a real-time message transmitting/receiving unit which enables users to individually transmit/receive real-time messages between them, wherein the recommending unit uses the real-time message transmitting/receiving unit, to notify the second user that the first user recommends the product to the second user.

This more specifically shows one example of the recommendation. According to this communication information processing unit, this unit enables users to individually transmit/receive real-time messages between them. The recommending unit uses the real-time message transmitting/receiving unit, to notify a message to the second user that the first user recommends the product. Therefore, it is possible to make recommendation to other users by using the real-time message of the communication system. Consequently, the user can easily make recommendation to other users. Further, it is also possible to increase the product advertising efficiency.

Further, according to a seventh aspect of the invention, there is provided the communication information processing unit in any one of the second to sixth aspects, further comprising, a real-time message transmitter/receiver extracting unit which extracts a user who has transmitted/received real-time messages to/from the first user, wherein the second user is the user who has been extracted by the real-time message transmitter/receiver extracting unit.

This more specifically shows one example of the recommendation. According to this communication information processing unit, this unit extracts a user who has exchanged real-time messages with the first user. The second user is the user who has been extracted. Therefore, it is possible to automatically make recommendation to users with whom real-time messages of the communication system have been exchanged in the past. Consequently, the user can easily make recommendation. Further, it is also possible to increase the product advertising efficiency.

Further, according to an eighth aspect of the invention, there is provided the communication information processing unit in any one of the second to seventh aspects, further comprising, an electronic mail transmitting/receiving unit which transmits/receives electronic mails to/from the users, wherein the recommending unit uses the electronic mail transmitting/receiving unit, to notify the second user that the first user recommends the product to the second user.

This more specifically shows one example of the recommendation. According to this communication information processing unit, this unit enables the users to exchange electronic mails between them. The recommending unit uses the electronic mail transmitting/receiving unit, to notify the second user that the first user recommends the product to the second user. Therefore, it is possible to make recommendation to other users by using the electronic mails of the communication system. Consequently, the user can easily make recommendation to other users. Further, it is also possible to increase the product advertising efficiency.

Further, according to a ninth aspect of the invention, there is provided the communication information processing unit in any one of the second to eighth aspects, further comprising, an electronic mail transmitter/receiver extracting unit which extracts a user who has transmitted/received electronic mails to/from the first user, wherein the second user is the user who has been extracted by the electronic mail transmitter/receiver extracting unit.

This more specifically shows one example of the recommendation. According to this communication information processing unit, this unit extracts a user who has exchanged electronic mails with the first user. The second user is the user who has been extracted. Therefore, it is possible to automatically make recommendation to users with whom electronic mails have been exchanged in the past. Consequently, the user can easily make recommendation. Further, it is also possible to increase the product advertising efficiency.

Further, according to a tenth aspect of the invention, there is provided the communication information processing unit in any one of the second to ninth aspects, further comprising, an online talking unit which provides an online talking including an electronic bulletin board or charts, wherein the recommending unit uses the online talking unit, to notify the second user that the first user recommends the product to the second user.

This more specifically shows one example of the recommendation. According to this communication information processing unit, this unit provides the user with an online talking including an electronic bulletin board or charts. The recommending unit uses the online talking unit, to notify the second user that the first user recommends the product to the second user. Therefore, it is possible to make recommendation to other users by using the online talking of the communication system. Consequently, the user can easily make recommendation to other users. Further, it is also possible to increase the product advertising efficiency.

Further, according to an eleventh aspect of the invention, there is provided the communication information processing unit in any one of the second to tenth aspects, further comprising, an online talker extracting unit which extracts a user who has carried out online talking with the first user, wherein the second user is the user who has been extracted by the online talker extracting unit.

This more specifically shows one example of the recommendation. According to this communication information processing unit, this unit extracts a user who has carried out online talking with the first user. The second user is the user who has been extracted. Therefore, it is possible to automatically make recommendation to users with whom online talking of the communication system has been carried out in the past. Consequently, the user can easily make recommendation. Further, it is also possible to increase the product advertising efficiency.

Further, according to a twelfth aspect of the invention, there is provided the communication information processing unit in any one of the second to eleventh aspects, further comprising, an online talking adding unit which adds information according to the online shopping in order to selling the product, to a note on the product information when there is this note on the product information while online talking is being carried out.

According to this communication information processing unit, this unit adds information according to the online shopping in order to sell the product, to a note on the product information when there is this note on the product information while online talking is being carried out. Therefore, when the product information is written into the note while the online talking of the communication system is being carried out, it is possible to automatically set a link to the URL of the online shopping site, and, it becomes possible to automatically give relevant information. Consequently, the user can easily make recommendation. Further, it is also possible to increase the product advertising efficiency.

Further, according to a thirteenth aspect of the invention, there is provided the communication information processing unit in any one of the second to twelfth aspects, further comprising, a homepage proving unit which provides the user with a homepage for the user, wherein the recommending unit uses the homepage proving unit, to notify the second user that the first user recommends the product to the second user.

This more specifically shows one example of the recommendation. According to this communication information processing unit, this unit provides the user with a homepage for the user. The recommending unit uses the homepage proving unit, to notify the second user that the first user recommends the product to the second user. Therefore, it is possible to make recommendation to other users by using the homepage of the user in the communication system. Consequently, the user can easily make recommendation to other users. Further, it is also possible to increase the product advertising efficiency.

Further, according to a fourteenth aspect of the invention, there is provided the communication information processing unit in any one of the second to thirteenth aspects, further comprising, a homepage access person extracting unit which extracts a user who has accessed the homepage of the first user, wherein the second user is the user who has been extracted by the homepage access person extracting unit.

This more specifically shows one example of the recommendation. According to this communication information processing unit, this unit extracts a user who has accessed the homepage of the first user. The second user is the user who has been extracted. Therefore, it is possible to automatically make recommendation to users who have accessed the homepage of the user in the communication system in the past. Consequently, the user can easily make recommendation. Further, it is also possible to increase the product advertising efficiency.

Further, according to a fifteenth aspect of the invention, there is provided the communication information processing unit in any one of the second to fourteenth aspects, wherein the recommending unit can notify the information terminal unit of the second user about at least one of the information on the online shopping site which sells the product, the product information on the product that the first user recommends, and the information on the first user.

This more specifically shows one example of the recommendation. According to this communication information processing unit, this unit can notify the information terminal unit of the second user about at least one of the information on the online shopping site which sells the product, the product information on the product that the first user recommends, and the information on the first user. Therefore, it is possible to send information that is necessary for the second user who receives the recommendation. Consequently, it is possible to recommend the product efficiently.

Further, according to a sixteenth aspect of the invention, there is provided the communication information processing unit in any one of the second to fifteenth aspects, wherein the communication information processing unit can notify the online shopping site which sells the product that the first user recommends the product to the information terminal unit of the second user.

According to this communication information processing unit, this unit can notify the online shopping site that sells the product that the first user recommends the product to the information terminal unit of the second user. Therefore, the online shopping site can know instantly that the own product is being recommended.

Further, according to a seventeenth aspect of the invention, there is provided an information terminal unit which is connected to a communication information processing unit via a network, and which structures a communication system in which users of information terminal units communicate with each other based on the control of the communication information processing unit, the information terminal unit comprising, a recommendation request transmitting unit which transmits to the communication information processing unit a recommendation request in which a first user recommends a second user a product that the online shopping site is selling.

According to this information terminal unit, this unit transmits to the communication information processing unit a recommendation request in which a first user recommends a second user a product that the online shopping site is selling. Therefore, it is possible to efficiently recommend a registered product to a user. Further, when the second user has purchased the product, the first user can receive kickback from the online shopping site. The user can efficiently transmit a product recommendation statement to many persons based on a simple operation. Therefore, an individual can easily work as an advertising medium, and also as an individual shop. This can maximize the power of the individual. Further, the online shopping can efficiently advertise the own product to users of the communication system.

Further, according to an eighteenth aspect of the invention, there is provided the information terminal unit of the seventeenth aspect, further comprising, a recommendation information receiving unit which receives the information about the first user recommending the product that has been transmitted from the communication information processing unit, based on the recommendation request that has been transmitted from the recommendation request transmitting unit, and an output unit which outputs the information received by the recommendation information receiving unit.

According to this information terminal unit, this unit receives the information about the first user recommending the product that has been transmitted from the communication information processing unit, based on the transmitted recommendation request, and outputs the received information. Therefore, it is possible to efficiently recommend a registered product to a user. Further, when the second user has purchased the product, the first user can receive kickback from the online shopping site. The user can efficiently transmit a product recommendation statement to many persons based on a simple operation. Therefore, an individual can easily work as an advertising medium, and also as an individual shop. This can maximize the power of the individual. Further, the online shopping can efficiently advertise the own product to users of the communication system.

Further, according to a nineteenth aspect of the invention, there is provided the information terminal unit of the seventeenth or eighteenth aspect, further comprising, a relevant-person storing unit which stores information on other users who have a predetermined relationship with the user, wherein the second user is a user who has been registered in the relevant-person storing unit as a person having a relationship with the first user.

This more specifically shows one example of the second user. According to this information terminal unit, this unit stores information on other users who have a predetermined relationship with the user. The second user is a user who has been registered as a person having a relationship with the first user. Therefore, when a user has a friend list that is provided by the communication system, the user can make recommendation to users who are on this list.

Further, according to a twentieth aspect of the invention, there is provided the information terminal unit in any one of the seventeenth to nineteenth aspects, wherein the product information includes product attribute information that is relevant to attributes of the product, the information terminal unit further comprises, a user attribute storing unit which stores user attribute information that is relevant to attributes of the user, and a user extracting unit which extracts the user who has the user attribute information relevant to the product attribute information of the product that has been recommended by the first user in the recommendation request, wherein the second user is the user who has been extracted by the user extracting unit.

This more specifically shows one example of the second user. According to this information terminal unit, the product information includes product attribute information that is relevant to attributes of the product. The information terminal unit further stores user attribute information that is relevant to attributes of the user, and extracts the user who has the user attribute information relevant to the product attribute information of the product that has been recommended by the first user in the recommendation request. The second user is the user who has been extracted. Therefore, it is possible to extract users who are interested in the product, and make recommendation to these extracted users. Consequently, it is possible to transmit information to the users that is useful for them. Further, it is also possible to increase the product advertising efficiency.

Further, according to a twenty-first aspect of the invention, there is provided the information terminal unit in any one of the seventeenth to twentieth aspects, wherein the user attribute information is at least one of user's information on gender, occupation, constellation, age, blood type, date of birth, hobby, special ability, address, resident area, interested genre, interested products, and signs of the zodiac.

This more specifically shows one example of the user attribute information. According to this information terminal unit, the user attribute information is at least one of user's information on gender, occupation, constellation, age, blood type, date of birth, hobby, special ability, address, resident area, interested genre, interested products, and signs of the zodiac. Therefore, it is possible to efficiently recommend a product that has product attributes relevant to these attributes.

Further, according to a twenty-second aspect of the invention, there is provided the information terminal unit in any one of the seventeenth to twenty-first aspects, further comprising, a real-time message transmitting/receiving unit which enables users to individually transmit/receive real-time messages between them, wherein the recommending unit uses the real-time message transmitting/receiving unit, to notify the second user that the first user recommends the product to the second user.

This more specifically shows one example of the recommendation. According to this information terminal unit, this unit enables users to individually transmit/receive real-time messages between them. The recommending unit uses the real-time message transmitting/receiving unit, to notify a message to the second user that the first user recommends the product. Therefore, it is possible to make recommendation to other users by using the real-time message of the communication system. Consequently, the user can easily make recommendation to other users. Further, it is also possible to increase the product advertising efficiency.

Further, according to a twenty-third aspect of the invention, there is provided the information terminal unit in any one of the seventeenth to twenty-second aspects, further comprising, a real-time message transmitter/receiver extracting unit which extracts a user who has transmitted/received real-time messages to/from the first user, wherein the second user is the user who has been extracted by the real-time message transmitter/receiver extracting unit.

This more specifically shows one example of the recommendation. According to this information terminal unit, this unit extracts a user who has exchanged real-time messages with the first user. The second user is the user who has been extracted. Therefore, it is possible to automatically make recommendation to users with whom real-time messages of the communication system have been exchanged in the past. Consequently, the user can easily make recommendation. Further, it is also possible to increase the product advertising efficiency.

Further, according to a twenty-fourth aspect of the invention, there is provided the information terminal unit in any one of the seventeenth to twenty-third aspects, further comprising, an electronic mail transmitting/receiving unit which transmits/receives electronic mails to/from the users, wherein the recommending unit uses the electronic mail transmitting/receiving unit, to notify the second user that the first user recommends the product to the second user.

This more specifically shows one example of the recommendation. According to this information terminal unit, this unit enables the users to exchange electronic mails between them. The recommending unit uses the electronic mail transmitting/receiving unit, to notify the second user that the first user recommends the product to the second user. Therefore, it is possible to make recommendation to other users by using the electronic mails of the communication system. Consequently, the user can easily make recommendation to other users. Further, it is also possible to increase the product advertising efficiency.

Further, according to a twenty-fifth aspect of the invention, there is provided the information terminal unit in any one of the seventeenth to twenty-fourth aspects, further comprising, an electronic mail transmitter/receiver extracting unit which extracts a user who has transmitted/received electronic mails to/from the first user, wherein the second user is the user who has been extracted by the electronic mail transmitter/receiver extracting unit.

This more specifically shows one example of the recommendation. According to this information terminal unit, this unit extracts a user who has exchanged electronic mails with the first user. The second user is the user who has been extracted. Therefore, it is possible to automatically make recommendation to users with whom electronic mails have been exchanged in the past. Consequently, the user can easily make recommendation. Further, it is also possible to increase the product advertising efficiency.

Further, according to a twenty-sixth aspect of the invention, there is provided the information terminal unit in any one of the seventeenth to twenty-fifth aspects, further comprising, an online talking unit which provides an online talking including an electronic bulletin board or charts, wherein the recommending unit uses the online talking unit, to notify the second user that the first user recommends the product to the second user.

This more specifically shows one example of the recommendation. According to this information terminal unit, this unit provides the user with an online talking including an electronic bulletin board or charts. The recommending unit uses the online talking unit, to notify the second user that the first user recommends the product to the second user. Therefore, it is possible to make recommendation to other users by using the online talking of the communication system. Consequently, the user can easily make recommendation to other users. Further, it is also possible to increase the product advertising efficiency.

Further, according to a twenty-seventh aspect of the invention, there is provided the information terminal unit in any one of the seventeenth to twenty-sixth aspects, further comprising, an online talker extracting unit which extracts a user who has carried out online talking with the first user, wherein the second user is the user who has been extracted by the online talker extracting unit.

This more specifically shows one example of the recommendation. According to this information terminal unit, this unit extracts a user who has carried out online talking with the first user. The second user is the user who has been extracted. Therefore, it is possible to automatically make recommendation to users with whom online talking of the communication system has been carried out in the past. Consequently, the user can easily make recommendation. Further, it is also possible to increase the product advertising efficiency.

Further, according to a twenty-eighth aspect of the invention, there is provided the information terminal unit in any one of the seventeen to twenty-seventh aspects, further comprising, an online talking adding unit which adds information according to the online shopping in order to sell the product, to a note on the product information when there is this note on the product information while online talking is being carried out.

According to this information terminal unit, this unit adds information according to the online shopping in order to sell the product, to a note on the product information when there is this note on the product information while online talking is being carried out. Therefore, when the product information is written into the note while the online talking of the communication system is being carried out, it is possible to automatically set a link to the URL of the online shopping site, and, it becomes possible to automatically give relevant information. Consequently, the user can easily make recommendation. Further, it is also possible to increase the product advertising efficiency.

Further, according to a twenty-ninth aspect of the invention, there is provided the information terminal unit in any one of the seventeenth to twenty-eighth aspects, further comprising, a homepage proving unit which provides the user with a homepage for the user, wherein the recommending unit uses the homepage proving unit, to notify the second user that the first user recommends the product to the second user.

This more specifically shows one example of the recommendation. According to this information terminal unit, this unit provides the user with a homepage for the user. The recommending unit uses the homepage proving unit, to notify the second user that the first user recommends the product to the second user. Therefore, it is possible to make recommendation to other users by using the homepage of the user in the communication system. Consequently, the user can easily make recommendation to other users. Further, it is also possible to increase the product advertising efficiency.

Further, according to a thirtieth aspect of the invention, there is provided the information terminal unit in any one of the seventeenth to twenty-ninth aspects, further comprising, a homepage access person extracting unit which extracts a user who has accessed the homepage of the first user, wherein the second user is the user who has been extracted by the homepage access person extracting unit.

This more specifically shows one example of the recommendation. According to this information terminal unit, this unit extracts a user who has accessed the homepage of the first user. The second user is the user who has been extracted. Therefore, it is possible to automatically make recommendation to users who have accessed the homepage of the user in the communication system in the past. Consequently, the user can easily make recommendation. Further, it is also possible to increase the product advertising efficiency.

Further, according to a thirty-first aspect of the invention, there is provided the information terminal unit in any one of the seventeenth to thirtieth aspects, wherein the recommendation information receiving unit receives from the communication information processing unit at least one of the information on the online shopping site which sells the product, the product information on the product that the first user recommends, and the information on the first user.

This more specifically shows one example of the recommendation. According to this information terminal unit, this unit can notify the information terminal unit of the second user about at least one of the information on the online shopping site which sells the product, the product information on the product that the first user recommends, and the information on the first user. Therefore, it is possible to send information that is necessary for the second user who receives the recommendation. Consequently, it is possible to recommend the product efficiently.

Further, according to a thirty-second aspect of the invention, there is provided the information terminal unit in any one of the seventeenth to thirty-first aspects, further comprising, a display screen information receiving unit which receives display screen information including a product purchasing button which purchases the product that the first user recommends, from the communication information processing unit, wherein the second user purchases the product by selecting the product purchasing button that has been received by the display screen information receiving unit, via an input unit.

According to this information terminal unit, this unit receives display screen information including a product purchasing button which purchases the product that the first user recommends, from the communication information processing unit. Therefore, the second user can purchase the desired product by selecting and clicking the product purchasing button via an input unit.

Further, according to a thirty-third aspect of the invention, there is provided the information terminal unit in any one of the seventeenth to thirty-second aspects, further comprising, an access unit which makes access to the online shopping site that sells the product, based on the information received by the recommendation information receiving unit.

According to this information terminal unit, it is possible to make access to the online shopping site that sells the product, based on the received information. Therefore, it is possible to purchase the product by instantly making access to the online shopping.

Further, according to a thirty-fourth aspect of the invention, there is provided a product recommendation method which uses a communication information processing unit that is connected to a plurality of information terminal units via a network, and that structures a communication system in which users of the information terminal units communicate with each other, the product recommendation method comprising, a product information storing step which stores product information that is relevant to a product that an online shopping site sells, a recommendation request receiving step which receives a recommendation request in which a first user recommends the desired product to a second user, and a recommending step which notifies to the second user that the first user recommends the product to the second user, based on the recommendation request that has been received at the recommendation request receiving step.

According to this product recommendation method, product information relevant to a product that an online shopping site sells is stored. A recommendation request in which a first user recommends the desired product is received, and information that the first user recommends the product to a second user is notified to the second user, based on the received recommendation request. Therefore, a server unit can efficiently recommend a registered product to a user. Further, when the second user has purchased the product, the first user can receive kickback from the online shopping site. The user can efficiently transmit a product recommendation statement to many persons based on a simple operation. Therefore, an individual can easily work as an advertising medium, and also as an individual shop. This can maximize the power of the individual. Further, the online shopping can efficiently advertise the own product to users of the communication system.

Further, according to a thirty-fifth aspect of the invention, there is provided the product recommendation method of the thirty-fourth aspect, further comprising, a relevant-person storing step which stores information on other users who have a predetermined relationship with the user, wherein the second user is a user who has been registered at the relevant-person storing step as a person having a relationship with the first user.

This more specifically shows one example of the second user. According to this product recommendation method, information on other users who have a predetermined relationship with the user is stored. The second user is a user who has been registered as a person having a relationship with the first user. Therefore, when a user has a friend list that is provided by the communication system, the user can make recommendation to users who are on this list.

Further, according to a thirty-sixth aspect of the invention, there is provided the product recommendation method of the thirty-fourth or thirty-fifth aspect, wherein the product information includes product attribute information that is relevant to attributes of the product, the product recommendation method further comprises, a user attribute storing step which stores user attribute information that is relevant to attributes of the user, and a user extracting step which extracts the user who has the user attribute information relevant to the product attribute information of the product that has been recommended by the first user in the recommendation request, wherein the second user is the user who has been extracted at the user extracting step.

This more specifically shows one example of the second user. According to this product recommendation method, the product information includes product attribute information that is relevant to attributes of the product. Further, user attribute information that is relevant to attributes of the user is stored, and the user is extracted who has the user attribute information relevant to the product attribute information of the product that has been recommended by the first user in the recommendation request. The second user is the user who has been extracted. Therefore, it is possible to extract users who are interested in the product, and make recommendation to these extracted users. Consequently, it is possible to transmit information to the users that is useful for them. Further, it is also possible to increase the product advertising efficiency.

Further, according to a thirty-seventh aspect of the invention, there is provided the product recommendation method in any one of the thirty-fourth to thirty-sixth aspects, wherein the user attribute information is at least one of user's information on gender, occupation, constellation, age, blood type, date of birth, hobby, special ability, address, resident area, interested genre, interested products, and signs of the zodiac.

This more specifically shows one example of the user attribute information. According to this product recommendation method, the user attribute information is at least one of user's information on gender, occupation, constellation, age, blood type, date of birth, hobby, special ability, address, resident area, interested genre, interested products, and signs of the zodiac. Therefore, it is possible to efficiently recommend a product that has product attributes relevant to these attributes.

Further, according to a thirty-eighth aspect of the invention, there is provided the product recommendation method in any one of the thirty-fourth to thirty-seventh aspects, further comprising, a real-time message transmitting/receiving step which enables users to individually transmit/receive real-time messages between them, wherein the recommending step uses the real-time message transmitting/receiving step, to notify the second user that the first user recommends the product to the second user.

This more specifically shows one example of the recommendation. According to this product recommendation method, users are enabled to individually transmit/receive real-time messages between them. The recommending step uses the real-time message transmitting/receiving step, to notify a message to the second user that the first user recommends the product. Therefore, it is possible to make recommendation to other users by using the real-time message of the communication system. Consequently, the user can easily make recommendation to other users. Further, it is also possible to increase the product advertising efficiency.

Further, according to a thirty-ninth aspect of the invention, there is provided the product recommendation method in any one of the thirty-fourth to thirty-eighth aspects, further comprising, a real-time message transmitter/receiver extracting step which extracts a user who has transmitted/received real-time messages to/from the first user, wherein the second user is the user who has been extracted at the real-time message transmitter/receiver extracting step.

This more specifically shows one example of the recommendation. According to this product recommendation method, a user who has exchanged real-time messages with the first user is extracted. The second user is the user who has been extracted. Therefore, it is possible to automatically make recommendation to users with whom real-time messages of the communication system have been exchanged in the past. Consequently, the user can easily make recommendation. Further, it is also possible to increase the product advertising efficiency.

Further, according to a fortieth aspect of the invention, there is provided the product recommendation method in any one of the thirty-fourth to thirty-ninth aspects, further comprising, an electronic mail transmitting/receiving step which transmits/receives electronic mails to/from the users, wherein the recommending step uses the electronic mail transmitting/receiving step, to notify the second user that the first user recommends the product to the second user.

This more specifically shows one example of the recommendation. According to this product recommendation method, the users are enabled to exchange electronic mails between them. The recommending step uses the electronic mail transmitting/receiving step, to notify the second user that the first user recommends the product to the second user. Therefore, it is possible to make recommendation to other users by using the electronic mails of the communication system. Consequently, the user can easily make recommendation to other users. Further, it is also possible to increase the product advertising efficiency.

Further, according to a forty-first aspect of the invention, there is provided the product recommendation method in any one of the thirty-fourth to fortieth aspects, the product recommendation method further comprising, an electronic mail transmitter/receiver extracting step which extracts a user who has transmitted/received electronic mails to/from the first user, wherein the second user is the user who has been extracted at the electronic mail transmitter/receiver extracting step.

This more specifically shows one example of the recommendation. According to this product recommendation method, a user who has exchanged electronic mails with the first user is extracted. The second user is the user who has been extracted. Therefore, it is possible to automatically make recommendation to users with whom electronic mails have been exchanged in the past. Consequently, the user can easily make recommendation. Further, it is also possible to increase the product advertising efficiency.

Further, according to a forty-second aspect of the invention, there is provided the product recommendation method in any one of the thirty-fourth to forty-first aspects, further comprising, an online talking step which provides an online talking including an electronic bulletin board or charts, wherein the recommending step uses the online talking step, to notify the second user that the first user recommends the product to the second user.

This more specifically shows one example of the recommendation. According to this product recommendation method, the user is provided with an online talking including an electronic bulletin board or charts. The recommending step uses the online talking step, to notify the second user that the first user recommends the product to the second user. Therefore, it is possible to make recommendation to other users by using the online talking of the communication system. Consequently, the user can easily make recommendation to other users. Further, it is also possible to increase the product advertising efficiency.

Further, according to a forty-third aspect of the invention, there is provided the product recommendation method in any one of the thirty-fourth to forty-second aspects, further comprising, an online talker extracting step which extracts a user who has carried out online talking with the first user, wherein the second user is the user who has been extracted at the online talker extracting step.

This more specifically shows one example of the recommendation. According to this product recommendation method, a user who has carried out online talking with the first user is extracted. The second user is the user who has been extracted. Therefore, it is possible to automatically make recommendation to users with whom online talking of the communication system has been carried out in the past. Consequently, the user can easily make recommendation. Further, it is also possible to increase the product advertising efficiency.

Further, according to a forty-fourth aspect of the invention, there is provided the product recommendation method in any one of the thirty-fourth to forty-third aspects, further comprising, an online talking adding step which adds information according to the online shopping in order to sell the product, to a note on the product information when there is this note on the product information while online talking is being carried out.

According to this product recommendation method, information according to the online shopping in order to sell the product is added to a note on the product information when there is this note on the product information while online talking is being carried out. Therefore, when the product information is written into the note while the online talking of the communication system is being carried out, it is possible to automatically set a link to the URL of the online shopping site, and, it becomes possible to automatically give relevant information. Consequently, the user can easily make recommendation. Further, it is also possible to increase the product advertising efficiency.

Further, according to a forty-fifth aspect of the invention, there is provided the product recommendation method in any one of the thirty-fourth to forty-fourth aspects, further comprising, a homepage proving step which provides the user with a homepage for the user, wherein the recommending step uses the homepage proving step, to notify the second user that the first user recommends the product to the second user.

This more specifically shows one example of the recommendation. According to this product recommendation method, the user is provided with a homepage for the user. The recommending step uses the homepage proving step, to notify the second user that the first user recommends the product to the second user. Therefore, it is possible to make recommendation to other users by using the homepage of the user in the communication system. Consequently, the user can easily make recommendation to other users. Further, it is also possible to increase the product advertising efficiency.

Further, according to a forty-sixth aspect of the invention, there is provided the product recommendation method in anyone of the thirty-fourth to forty-fifth aspects, further comprising, a homepage access person extracting step which extracts a user who has accessed the homepage of the first user, wherein the second user is the user who has been extracted at the homepage access person extracting step.

This more specifically shows one example of the recommendation. According to this product recommendation method, a user who has accessed the homepage of the first user is extracted. The second user is the user who has been extracted. Therefore, it is possible to automatically make recommendation to users who have accessed the homepage of the user in the communication system in the past. Consequently, the user can easily make recommendation. Further, it is also possible to increase the product advertising efficiency.

Further, according to a forty-seventh aspect of the invention, there is provided the product recommendation method in anyone of the thirty-fourth to forty-sixth aspects, wherein at the recommending step it is possible to notify the information terminal unit of the second user about at least one of the information on the online shopping site which sells the product, the product information on the product that the first user recommends, and the information on the first user.

This more specifically shows one example of the recommendation. According to this product recommendation method, it is possible to notify the information terminal unit of the second user about at least one of the information on the online shopping site which sells the product, the product information on the product that the first user recommends, and the information on the first user. Therefore, it is possible to send information that is necessary for the second user who receives the recommendation. Consequently, it is possible to recommend the product efficiently.

Further, according to a forty-eighth aspect of the invention, there is provided the product recommendation method in any one of the thirty-fourth to forty-seventh aspects, wherein it is possible to notify the online shopping site which sells the product that the first user recommends the product to the information terminal unit of the second user.

According to this product recommendation method, it is possible to notify the online shopping site which sells the product that the first user recommends the product to the information terminal unit of the second user. Therefore, the online shopping site can know instantly that the own product is being recommended.

Further, according to a forty-ninth aspect of the invention, there is provided a program which stores a product recommendation method in any one of the thirty-fourth to forty-eighth aspects, and which makes a computer execute this product recommendation method.

According to this recording medium, it is possible to realize a product recommendation method in any one of the thirty-fourth to forty-eighth aspects, by making a computer read and execute the program. It is possible to obtain similar effects to those of the above product recommendation methods.

Other objects and features of this invention will become understood from the following description with reference to the accompanying drawings.

### BRIEF DESCRIPTION OF THE DRAWINGS

FIG. 1 is a block diagram showing one example of a total structure of the present system;

FIG. 2 is a conceptual diagram showing one example of a service image of the present system according to a first embodiment of the present invention;

FIG. 3 is a conceptual diagram showing one example of a service image of the present system according to a second embodiment of the present invention;

FIG. 4 is a block diagram showing one example of a structure of a server unit 100 to which the present invention is applied;

FIG. 5 is a flowchart showing one example of a product recommendation processing of the present system according to the present embodiment;

FIG. 6 is a flowchart showing one example of a product recommendation processing of the present system according to the present embodiment;

FIG. 7 is a diagram showing one example of a display screen of a web page which sells a product A that is displayed on a monitor of a client unit 200;

FIG. 8 is a diagram showing one example of a display screen of an electronic mail or a real-time message for production recommendation that is transmitted by an electronic mail processing section 102d;

FIG. 9 is a diagram showing one example of a display screen of a web page which displays a BBS of a user A that is displayed on a monitor of a client unit 200;

FIG. 10 is a diagram showing one example of a display screen of a web page which displays a homepage of a user A that is displayed on a monitor of a client unit 200.

### DETAILED DESCRIPTIONS

The present invention relates to a communication system, a communication information processing unit, an information terminal unit, a product recommendation method, and a program that can comprehensively provide real-time messages, electronic mails, electronic bulletin boards, and chats to users.

Embodiments of a communication system, a communication information processing unit, an information terminal unit, a product recommendation method, and a program according to the present invention will be explained in detail with reference to the drawings. It should be noted that the present invention is not limited to the following embodiments.

In the following embodiments, examples of the application of the present invention to an online shopping system on the Internet will be explained. The application is not limited to this, and it is also possible to similarly apply the present invention to all systems that recommend products to be online transacted such as the online shopping on a mobile communication network using portable telephones or the like.

(Outline of the Present System)

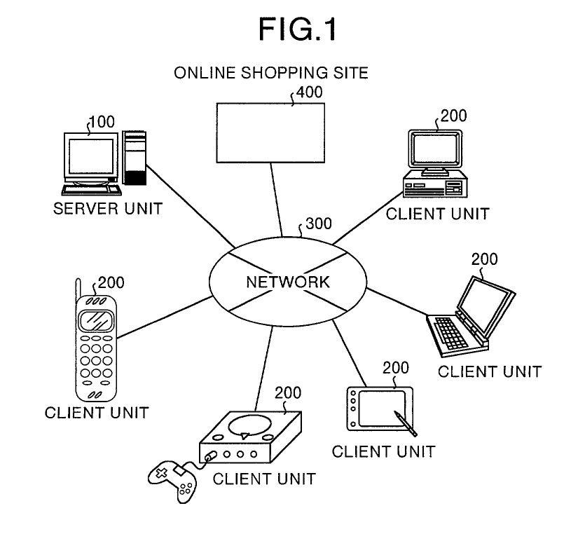

The outline of the present system will be explained first, and then the structure and the processing of the present system will be explained in detail. FIG. 1 is a block diagram showing one example of a total structure of the present system. This shows a concept of only portions of the system that relate to the present invention.

The present system is structured based on the connection between a server unit 100 and client units 200 via a network 300, such that the users can communicate with each other. The server unit 100 is a communication information processing unit which creatively provides various communication units to users, and the client units 200 are information terminal units for the users of the present system. Further, an online shopping site 400 which sells products online is also connected to the present system via the network 300.

This system has the following basic characteristics. Various kinds of information according to communication are transmitted from the server unit 100 to the client units 200, or from the client units 200 to the server unit 100, via the network 300. Various kinds of communication services are provided to the users, based on these information exchanges. The server unit 100 receives and stores product information according to products (the “product” includes a product that is relevant to service like a financial product, for example) that the online shopping site 400 sells. The server unit 100 receives a recommendation request in which a user recommends a desired product, from the online shopping site 400 or the client unit 200 via the network 300. Then, the server unit 100 notifies other users that the user (the recommender) recommends the product to these other users, based on this recommendation request, using various kinds of communication services.

As main communication services that are provided in the present system, there are a publication of homepages, online talking like chatting and a BBS, electronic mails, and real-time messages (or private messages (PB messages), which are also called instant messages). As auxiliary services that assist smooth execution of these services, there are a profile reference, an online URL location list, a WWWURL location list, a fried list, and a refusal list. It is possible to use these services individually. It is also possible to use a plurality of these services simultaneously or linked to each other on the same screen.

Among the main services, the “publication of homepage” is a service that enables a user to read web pages of other users stored in the present system or in an external server, at the client unit.

The “online talking” is a service that provides chatting in which users can talk with each other using a virtual chat room, and a bulletin board (BBS) on which a user can write information using a virtual bulletin board. Particularly, in the present system, the “online talking” has a characteristic that, in addition to a conventional general chatting, it is possible to actively open a chat room to other users.

The “real-time message” is a service that enables a user to send individual messages to other users. Particularly, in the present system, the “real-time message” has a characteristic that, as compared with the conventional electronic mails, this has real-time characteristic, and it is possible to actively send messages to other users.

Among the auxiliary services, the “profile reference” is a service that enables a user of each client unit to register an own profile in the server unit, and also enable other user to refer to this profile when necessary. By referring to this profile, each user can easily prepare a friend list or a refusal list, as described later.

The “online URL location list” is a service that provides each user with information on the existence of other users who are online in the present system.

The “WWWURL location list” is a service that provides each user of the WWW service with information on the existence of other users who read the same web page as that the user is reading.

By referring to the online URL location list and the WWWURL location list, each user can easily find other users who have the same hobby as that the user has, for example. By referring to these lists, each user can easily prepare a friend list or a refusal list, as described later.

The “friend list” is a service that enables each user to register other users as own friends, in the server unit. A user can refer to this friend list at the time of selecting a transmission destination in the chart service or the PB message service. This makes it possible to expand a communication range, and also facilitates a remote operation.

The “refusal list” is a service that enables each user to register other users as users (refused users) with whom the user does not want to make communications. When there has been an invitation call which invites the user to participate in chatting, or a PB message, from the refused user who have registered in the refusal list, it is possible to automatically refuse these communication requests.

(System structure)

A structure of the present system will be explained to make clear the basic characteristics.

(System Structure—Server Unit 100)

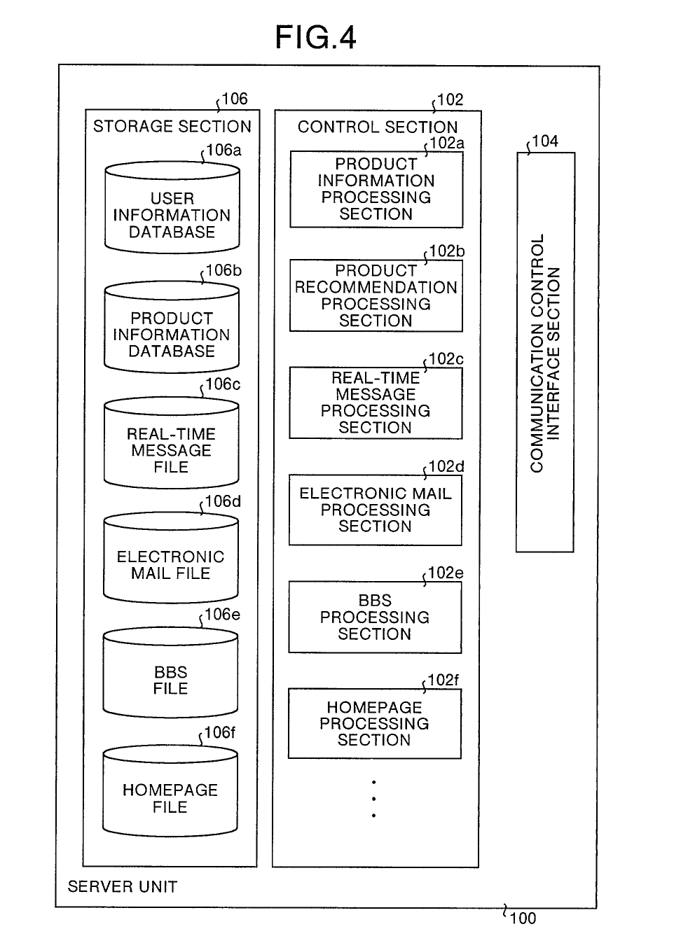

A structure of the server unit 100 will be explained first. FIG. 4 is a block diagram showing one example of a structure of the server unit 100 to which the present invention is applied. This shows a concept of only portions of the system that relate to the present invention. Referring to FIG. 4, the server unit 100 is constructed of a control section 102 like a CPU which controls the server unit 100 in total, a communication control interface section 104 which is connected to a communication unit (not shown) like a router that is connected to a communication line or the like, and a storage section 106 which stores various kinds of databases (a user information database 106a to a homepage file 106f). These sections are connected to each other via an optional communication line so that it is possible to carry out communications. Further, this server unit is also connected to the network 300 via a communication unit like a router and a cable or radio communication like an exclusive line.

The various kinds of databases (the user information database 106a to the homepage file 106f) that are stored in the storage section 106 are storage units like fixed disk units. These databases store various kinds of programs, tables, files, databases, and web pages that are used for various kinds of processing and web sites.

Among these constituent elements of the storage section 106, the user information database 106a is a user information storing unit which stores information on users. The user information database 106a stores user identifiers that uniquely identify users, and user management information which manages these users, by relating these users to each other.

The “user management information” includes, for example, a user ID, a password, a communication ID, and various kinds of information on each user of this system. The information on each user includes a nick name (a handle name) of the user, gender of the user, occupation, constellation, age, blood type, date of birth, hobby, special ability, address, resident area (for example, name of country, name of prefecture, etc.), interested genre (for example, shopping, music, securities and financing, news, computer, etc.), interested products, URL of own homepage or homepage name, and signs of the zodiac, friend information, refusal information, an list of inhibited users, game history information according to user's history of game (for example, name of game, number of stages, game records, scores, time, etc.), information on genre of interested games (for example, sports games, simulation games, sport combative, race games, etc.), and information on characters of interested games. The information is not limited to text data, and it is also possible to store binary data of images and sounds and voices. It is possible to register the information at an optional timing after each user has joined the present system. It is possible to edit the information according to the needs.

Among the above information, the “user ID” is identification information (first identification information) that is given from an ISP (Internet service provider) to a user to uniquely identify this user, when the user has made a line utilization contract with this ISP which connects the own clientunit 200 to the Internet. Each user registers an optional password that only the user and the ISP can know. As the ISP, there is used an ISP (tied ISP) that is in tied relationship with the present system which provides predetermined information.

The “communication ID” is identification information (second identification information) that is given to the user from the server unit 100 when the user joins the present system, to uniquely identify this user within the system.

The “friend information” is information that uniquely specifies other users who have been registered as friends by each user. The “refusal information” is information that uniquely specifies other users who have been registered as refused users by each user. Specifically, the friend information and the refusal information are structured by using the user ID's.

The “list of inhibited users” is a list that uniquely specifies inhibited users in order to inhibit the utilization of the present system by these users, when there are users who have acted undesirable behaviors on legal or ethical aspects within the present system, or when there are users who are inhibited to utilize the present system for other optional reasons. This list of inhibited users consists of user ID's of the inhibited users, and this list is stored at an optional timing by the manager of the present system.

The product information database 106b is a product information storing unit which stores information on products by the online shopping site 400. The product information database 106b stores product information that uniquely identifies products, product attribute information according to the attributes of the product (for example, relevant persons who like the product, production areas, selling areas, quality, quantity, price, etc.), and information according to the online shopping site 400 that sells the products (for example, address of URL, name of an electronic shop, providers, etc.), by relating these information to each other.

The real-time message file 106c is a real-time message information storing unit which stores information according to real-time messages. The real-time message file 106c stores real-time message identifiers which uniquely identify real-time messages, mail transmitter identifiers, mail receiver identifiers, and message data, by relating these information to each other.

The electronic mail file 106d is an electronic mail information storing unit which stores information according to electronic mails. The electronic mail file 106d stores electronic mail identifiers which uniquely identify electronic mails, mail transmitter identifiers, mail receiver identifiers, and electronic mail data, by relating these information to each other.

The BBS file 106e is an online talking information storing unit which stores information according to online talking (like a BBS). The BBS file 106e stores online talking identifiers which uniquely identify online talking, identifiers of BBS managers, identifiers of writers, and written data for online talking, by relating these information to each other.

The homepage file 106f is a homepage information storing unit which stores information according to users homepages. The homepage file 106f stores homepage identifiers which uniquely identify users' homepages, identifiers of homepage managers, and web data of homepages, by relating these information to each other.

As other information, the storage section 106 of the server unit 100 stores various kinds of web data, and CGI programs, which provide web sites to the client units 200.

Referring to FIG. 4, the communication control interface section 104 carries out control of communications between the server unit 100 and the network 300 (or communication units like routers). In other words, the communication control interface section 104 has a function of communicating data with other terminals via communication lines.

In FIG. 4, the control section 102 has internal memories which store control programs of an OS (operating system) and others, programs which prescribe various kinds of processing procedures, and required data. The control section 102 carries out information processing which executes various kinds of processing, based on these programs. The control section 102 is constructed of a product information processing section 102a, a product recommendation processing section 102b, a real-time message processing section 102c, an electronic mail processing section 102d, a BBS processing section 102e, and a homepage processing section 102f.

Among these sections, the product information processing section 102b is a product information processing unit which processes product information that has been received from the online shopping site 400. The product recommendation processing section 102b is a product recommendation processing unit which recommends a product recommended by a user, to other users. The real-time message processing section 102c is a real-time message processing unit which provides real-time message services. The electronic mail processing section 102d is an electronic mail processing unit which provides electronic mail services. The BBS processing section 102e is a BBS processing unit which provides online talking (BBS) service which provides online talking like electronic bulletin boards and chatting. The homepage processing section 102f is a homepage processing section which provides homepages of users. Detailed processing of these sections will be explained later.

(System Structure—Client Unit 200)

A structure of the client unit 200 will be explained next. The client unit 200 is constructed of a control section, a ROM, a RAM, an HD, an input unit, an output unit, an input/output control IF, and a communication control IF. These sections are connected to each other via a bus so that it is possible to carry out data communications.

The control section of the client unit is constructed of a web browser and an electronic mailer. The web browser is to carrying out a display control (brows processing) of a display on a monitor to be described later, by interpreting web data. The electronic mailer transmits/receives electronic mails according to a predetermined communication rule (for example, SMTP (simple mail transfer protocol)).

For the input unit, it is possible to use a keyboard, a mouse, and microphone. The monitor to be described later also realizes a pointing device function in co-operation with the mouse.

For the output unit, it is possible to use a speaker in addition to the monitor (including a home television) In the subsequent explanation, the output unit will be described as a monitor.

The communication control IF carries out control of communications between the client unit 200 and the Internet (or a communication unit like a router). This communication control IF is a communication unit which communicates with the network 300.

The client unit 200 having the above structure is connected to the Internet, via a modem, a TA, a communication unit like a router, and a telephone line, or via an exclusive line. The client unit 200 can make access to the server unit 100 according to a predetermined communication rule (for example, TCP/IP Internet protocol).

(System Structure—Network 300)

A structure of the network 300 will be explained next. The network 300 has a function of connecting the server unit 100 and the client unit 200 to each other. The network 300 is the Internet, for example.

(System Structure—Online Shopping Site 400)

A structure of the online shopping site 400 will be explained next. The online shopping site 400 is connected to the server unit 100 and the client unit 200 to each other, via the network 300, and has a function of providing an online shopping site of a product to users. The online shopping site 400 may be structured as a web server or an ASP server. The hardware of the online shopping site 400 may be structured by a workstation, an information processing unit like a personal computer, and auxiliary units, that are generally available in the market. Functions of the online shopping site 400 explained below are realized by the CPU, a disk unit, a memory unit, an input unit, an output unit, a communication control unit, and programs which controls these units.

(Processing of the System)

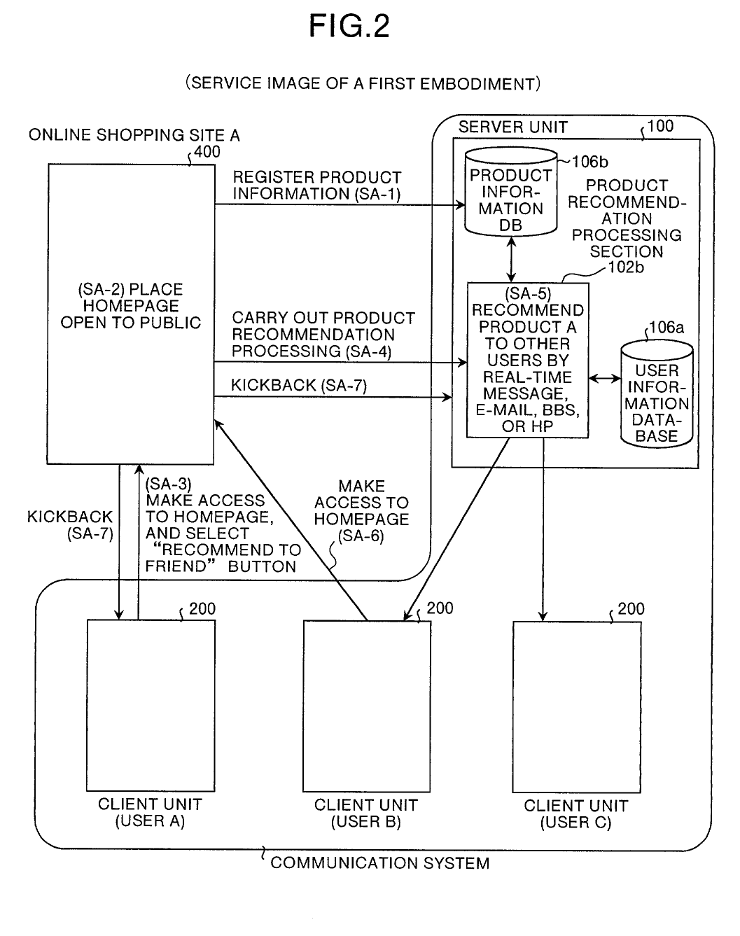

One example of the processing of the present system according to the present embodiment having the above structure will be explained in detail with reference to FIGS. 2, 3, and 5 to 10.

(Service Image of a First Embodiment)

A service image of a first embodiment of the present method using the present system having the above structure will be explained in detail with reference to FIG. 2. FIG. 2 is a conceptual diagram showing one example of the service image of the present system according to the first embodiment.

The online shopping site 400 transmits product information of a product that the online shopping site sells, to the server unit 100, at step SA-1. Further, the online shopping site 400 places a homepage open to the public in order to sell a product A by online shopping, at step SA-2.

The “product information” to be transmitted to the server unit 100 includes product attribute information according to the attributes of the product (for example, relevant persons who like the product, production areas, selling areas, quality, quantity, price, etc.), and information according to the online shopping site 400 that sells the product (for example, address of URL, name of an electronic shop, providers, etc.). The product information can be transmitted based on a conventional technique like the FTP, and therefore, detailed explanation of this transmission method will be omitted here.

In the server unit 100, the product information processing section 102a adds a product information identifier to the received product information, and registers this information to the product information database 106b. The product information processing section 102a of the server unit 100 displays the registered product information as a banner advertising, for example, and advertises the product to the users, in various kinds of communication services provided by the server unit 100.

When a user A has specified an address of a web site (URL or the like) provided by the server unit 100 on the screen like browser software via the input unit, the client unit 200 of the user A is connected to the server unit 100 via the Internet. The connection to the web site and the reading of the web site can be carried out based on a conventional technique, and therefore, detailed explanation of these methods will be omitted here.

When the user A has clicked the banner advertising according to the product A on the web site of the server unit 100, the client unit 200 of the user A is automatically connected to the online shopping site 400. Then, the web page which sells the product A that is opened on the online shopping site 400 is displayed on the monitor of the client unit 200 based on the function of the browser software.

FIG. 7 is a diagram showing one example of a display screen of the web page which sells the product A that is displayed on the monitor of the client unit 200. As shown in FIG. 7, the display screen of the web page which sells the product A consists of an area MA-1 that displays the explanation of the product A, a purchase selection button MA-2 that displays a purchase of the product A, and a recommendation selection button MA-3 that displays a selection of a recommendation of the product A to friends.

Referring back to FIG. 2, when the user A has clicked the mouse to select the friend recommendation button MA-3 at step SA-3, the user identifier of the user A stored in the storage section of the client unit 200 is transmitted to the online shopping site 400.

When the online shopping site 400 has received the user identifier of the user A, the online shopping site 400 transmits to the server unit 100 a product recommendation processing request that requests the server unit 100 to notify a message that the user A recommends the product A to other users, at step SA-4.

When the server unit 100 has received the product recommendation processing request, the product recommendation processing section 102b refers to the user information database 106a and the product information database 106b, and executes the product recommendation processing which recommends the product A to other users, at step SA-5.

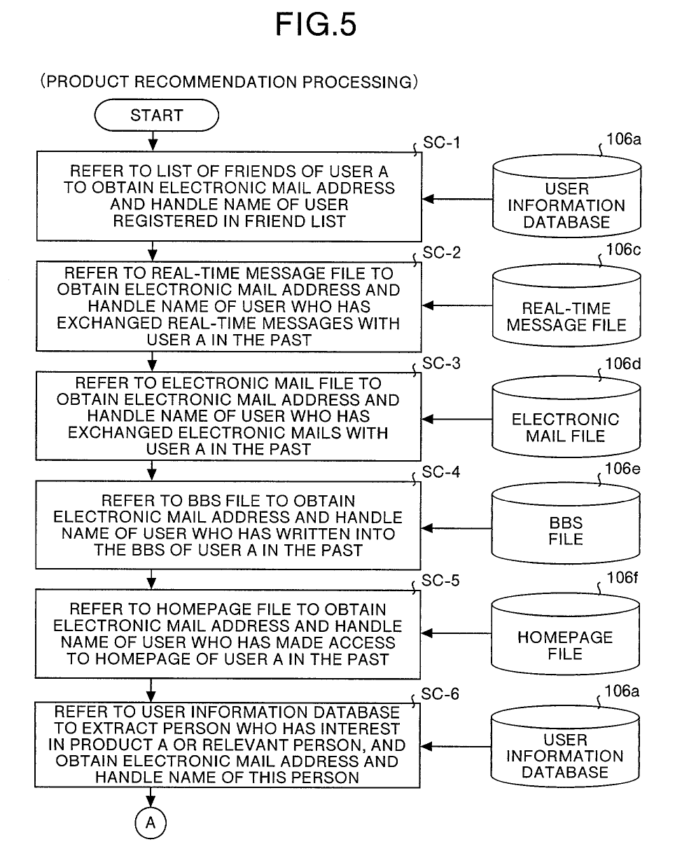

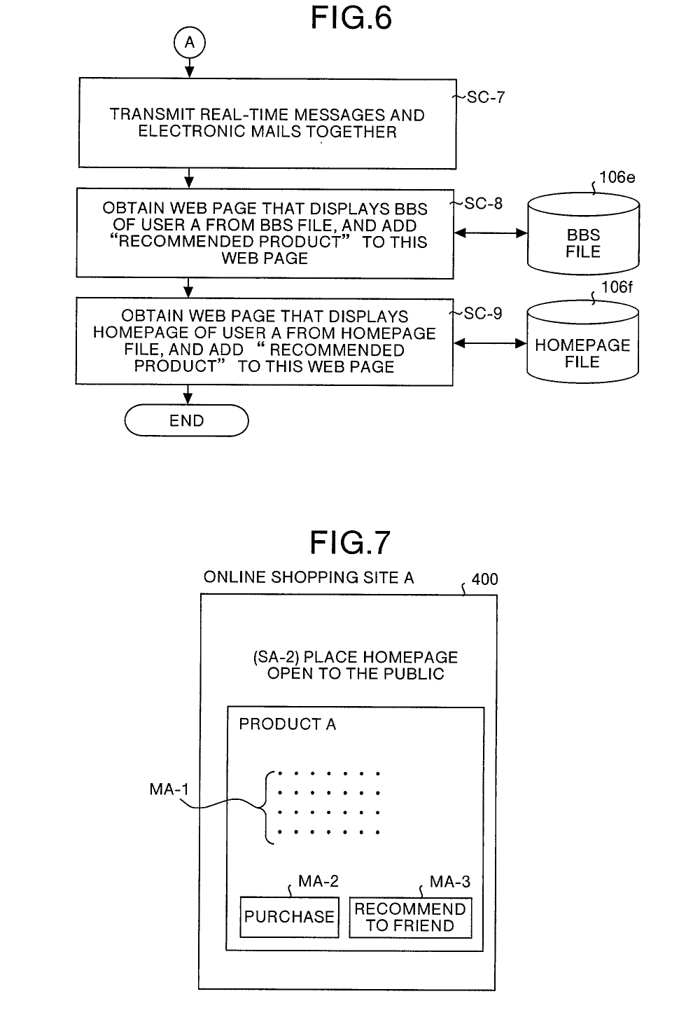

The product recommendation processing of the present system will be explained in detail with reference to FIG. 5 and FIG. 6. FIGS. 5 and 6 are flowcharts showing one example of a product recommendation processing of the present system according to the present embodiment.

The product recommendation processing section 102b of the server unit 100 refers to the user information database 106a, and refers to the list of the friends of the user A, thereby to obtain an electronic mail address and a handle name of a user registered in the friend list, at step SC-1.

Next, the product recommendation processing section 102b of the server unit 100 refers to the real-time message file 106c, and obtains an electronic mail address and a handle name of a user who has exchanged real-time messages with the user A in the past, at step SC-2.

The product recommendation processing section 102b of the server unit 100 refers to the electronic mail file 106d, and obtains an electronic mail address and a handle name of a user who has exchanged electronic mails with the user A in the past, at step SC-3.

The product recommendation processing section 102b of the server unit 100 refers to the BBS file 106e, and obtains an electronic mail address and a handle name of a user who has written into the BBS of the user A in the past, at step SC-4.

The product recommendation processing section 102b of the server unit 100 refers to the homepage file 106f, and obtains an electronic mail address and a handle name of a user who has made access to the homepage of the user A in the past, at step SC-5.

The product recommendation processing section 102b of the server unit 100 refers to the product information database 106b, and extracts product attributes of the product A. The product recommendation processing section 102b refers to the user information database 106a, and refers to the attribute information of the product A, thereby to obtain an electronic mail address and a handle name of a user who coincides with the attribute information of the product A, at step SC-6.

The electronic mail processing section 102d transmits electronic mails in order to recommend the product A, by using the electronic mail addresses extracted at steps SC-1 to SC-6 as addresses, at step SC-7. The electronic mail processing section 102d may transmit electronic mails to all the electronic mail addresses that have been extracted. Alternatively, the electronic mail processing section 102d may transmit electronic mails to electronic mail addresses of only a part of users who have been selected by the user, the server unit 100, or the online shopping site 400.

The electronic mail processing section 102d transmits real-time messages in order to recommend the product A, by using the handle names extracted at steps SC-1 to SC-6 as addresses, at step SC-7. The electronic mail processing section 102d may transmit real-time messages to all the handle names that have been extracted. Alternatively, the electronic mail processing section 102d may transmit real-time messages to handle names of only a part of users who have been selected by the user, the server unit 100, or the online shopping site 400.

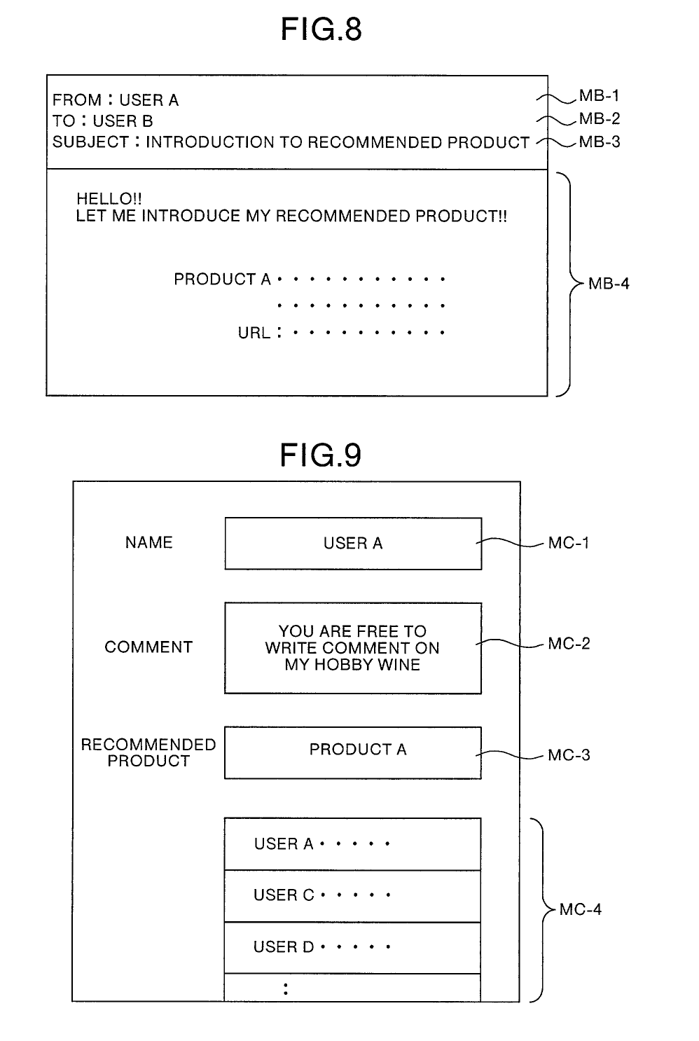

FIG. 8 is a diagram showing one example of a display screen of an electronic mail or a real-time message for production recommendation that is transmitted by the electronic mail processing section 102d. As shown in FIG. 8, the display screen of an electronic mail or a real-time message for production recommendation consists of an area MB-1 that shows a transmitter, an area MB-2 that shows a receiver, an area MB-3 that shows a subject, and an area MB-4 that shows a main statement of the electronic mail or the real-time message. The area MB-4 that shows a main statement of the electronic mail or the real-time message may show at least only a part of the product information according to the product A.

The product recommendation processing section 102b refers to the BBS processing section 120e to obtain a web page that displays the BBS of the user A, and the product recommendation processing section 102b adds information of “recommended product” to this web page, at step SC-8. The product recommendation processing section 102b sets link information to the portion of the “recommended product” in order to make a linkage to the web page according to the product information of the product A. Based on this, the BBS processing section 102e transmits the web page which displays the BBS of the user A to the client unit 200 of the user, and outputs the web page which displays the BBS of the user A to the monitor of the client unit 200.

FIG. 9 is a diagram showing one example of a display screen of a web page which displays the BBS of the user A that is displayed on the monitor of the client unit 200. As shown in FIG. 9, the display screen of the web page which displays the BBS of the user A consists of an area MC-1 that displays a user who provides the BBS, an area MC-2 that displays a comment, an area MC-3 that shows a recommended product, and an area MC-4 that shows a main statement written on the BBS.

When at least a part of the product information according to the product A is described in the area MC-4 that shows a main statement written on the BBS, the BBS processing section 102e may set link information to the portion of the area MC-4 in order to make a linkage to the web page according to the product information of the product A. In other words, the BBS processing section 102e refers to the product information database 106b, and checks whether the product information is included in the contents written by the user. When the product information is included in the contents written by the user, the BBS processing section 102e sets the link information to the contents, based on the address information of the online shopping site 400 that provides this product information.

Next, the product recommendation processing section 102b refers to the homepage processing section 102f to obtain the web page which displays the homepage of the user A, and adds the information of the “recommended product” to this web page, at step SC-8. The product recommendation processing section 102b sets the link information to the portion of the “recommended product” in order to make a linkage to the web page according to the product information of the product A. The homepage processing section 102f transmits the web page which displays the homepage of the user A to the client unit 200 of the user, and the web page which displays the homepage of the user A is output to the monitor of the client unit 200.

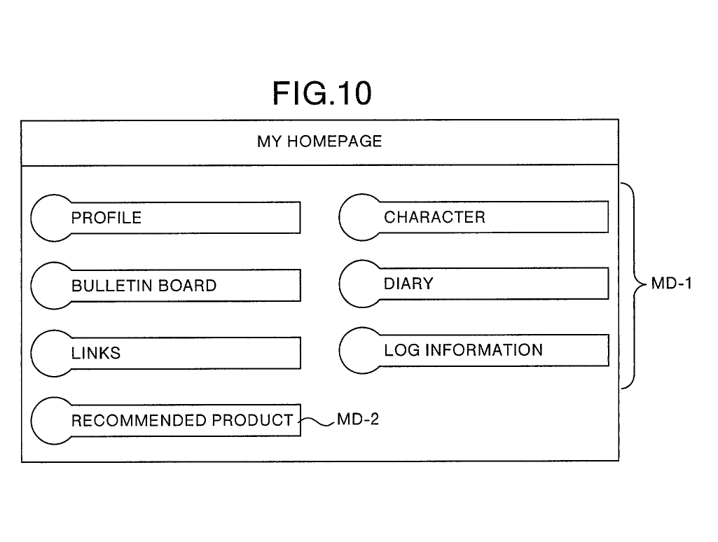

FIG. 10 is a diagram showing one example of a display screen of a web page which displays a homepage of the user A that is displayed on the monitor of the client unit 200. As shown in FIG. 10, the display screen of a web page which displays a homepage of the user A consists of an area MD-1 that shows information according to a user who provides the homepage, and an area MD-2 that shows a recommended product. The product recommendation processing finishes there.

Referring back to FIG. 2, when the product A has been recommended to the client unit 200 of other users at step SA-5, a user who has interest in the product A among these users makes access to the online shopping site 400 based on the recommendation information, at step SA-6.

When a recommended user B has purchased the product A, the online shopping site 400 makes kickback to the user A who has recommended the product A, and the server unit 100, at step SA-7.

(Service Image of a Second Embodiment)

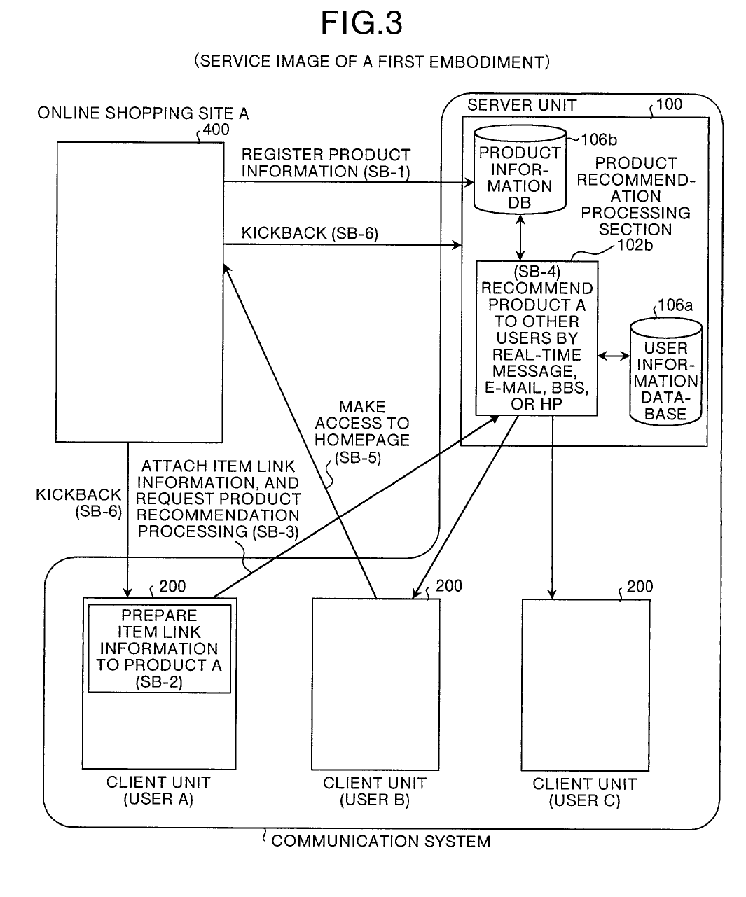

A service image of a second embodiment of the present method using the present system having the above structure will be explained in detail with reference to FIG. 3. FIG. 3 is a conceptual diagram showing one example of the service image of the present system according to the second embodiment. The explanation of the portions explained in the first embodiment will be omitted here.

The online shopping site 400 transmits product information of a product that the online shopping site sells, to the server unit 100, at step SB-1.

In the server unit 100, the product information processing section 102a adds a product information identifier to the received product information, and registers this information to a product information database 106b. The product information processing section 102a of the server unit 100 displays the registered product information as a banner advertising, for example, and advertises the product to the users, in various kinds of communication services provided by the server unit 100.

When a user A has specified an address of a web site (URL or the like) provided by the server unit 100 on the screen like browser software via the input unit, the client unit 200 of the user A is connected to the server unit 100 via the Internet. The connection to the web site and the reading of the web site can be carried out based on a conventional technique, and therefore, detailed explanation of these methods will be omitted here.

When the user A has clicked the banner advertising according to the product A on the web site of the server unit 100, the client unit 200 of the user A is automatically connected to the online shopping site 400. Then, the web page which sells the product A that is opened on the online shopping site 400 is displayed on the monitor of the client unit 200 based on the function of the browser software.

When the user A recommends the product A to other users, the client unit 200 prepares item link information according to the product A, at step SB-2. The item link information includes a product identifier, and a user identifier. The item link information may further include a recommendation statement.

The client unit 200 transmits a product recommendation processing request attached with the item link information of the user A, to the server unit 100, at step SB-3.

The server unit 100 receives the product recommendation processing request, and the product recommendation processing section 102b refers to the user information database 106a and the product information database 106b, and executes a product recommendation processing which recommends the product A to other users, at step SB-4.

The server unit 100 may notify the online shopping site 400 that sells the product A that the user A recommends the product A to the user B. Based on this, the online shopping site can know instantly that the own product is being recommended.

When the product A has been recommended to the client unit 200 of other users, a user who has interest in the product A among these users makes access to the online shopping site 400 based on the recommendation information, at step SB-5.

When a recommended user B has purchased the product A, the online shopping site 400 makes kickback to the user A who has recommended the product A, and the server unit 100, at step SB-6.

(Other Embodiments)

While the embodiments of the present invention have been explained above, the present invention can also be applied to various other embodiments within the range of the technical idea of claims for a patent.

For example, in the above embodiments, a product is recommended to users who have been registered in the friend list. However, it is also possible to recommend the product to persons relevant to the recommending user who have been registered in the online URL relocation list, the WWWURL relocation list, and the refusal list.

Further, a person skilled in the art can easily understand that the client unit 200 can execute at least a part of the processing executed by the server unit 100.

The server unit 100 may transmit to the client unit 200 the display screen information including a product purchase button which purchases the product recommended by the user. With this arrangement, a user can click the product purchasing button with the mouse while looking at the display screen that includes the product purchasing button displayed on the monitor of the client unit 200. Based on this, it is possible to automatically transmit a purchase indication including a user identifier and a product name to the server unit 100 or the online shopping site 400. When the server unit 100 or the online shopping site 400 has received the purchase indication, the server unit 100 or the online shopping site 400 can execute a predetermined purchase processing. Therefore, a user who has received the recommendation can purchase a predetermined product, by clicking the purchasing button on the display screen.

As communication units between the online shopping site 400 and the client unit 200, it is possible to use various kinds of communication services that are provided by the server unit 100. Based on this, a user can communicate with the online shopping site 400 using various kinds of communication services. Therefore, it becomes more convenient. Further, when a user who has received the recommendation uses a real-time message in order to make access to the online shopping site 400 about the recommended product, the user can access more easily.

It is possible to manually execute the whole or a part of the processing that has been explained to be automatically executed in the above embodiments. It is also possible to automatically execute based on a known method the whole or a part of the processing that has been explained to be manually executed in the above embodiments.

Except where explained otherwise, it is possible to optionally change a processing procedure, a control procedure, a detailed name, information including various kinds of registration data and parameters of search conditions, an example of a screen, and a data structure, that have been explained in the specification and the drawings.

The constituent elements of the server unit 100 in the drawings show the concept of functions, and it is not always necessary to have a physical structure as shown in the drawings.

A CPU (central processing unit) or a program that is interpreted and executed by the CPU can realize the whole or a part of the processing functions of each server of the server unit 100, particularly, each processing function executed by the control section. It is also possible to realize these functions as hardware according to a wired logic. The program is recorded on a main recording medium not shown, and the server unit 100 mechanically reads this program when necessary.

The server unit 100 may further include an input unit (not shown) consisting of various kinds of pointing devices like a mouse, a keyboard, an image scanner, and a digitizer, a display unit (not shown) that is used to monitor the input data, a clock generating section (not shown) that generates a system clock, and an output unit (not shown) like a printer that outputs various kinds of processing results and other data. The input unit, the display unit, and the output unit may be connected to the control section 102 via an input/output interface respectively.

Various kinds of databases that are stored in the storage section (the user information database 106a to the homepage file 106f) are memory units like a RAM and a ROM, fixed disk units like a hard disk, and storage units like a flexible disk and an optical disk. These databases store various programs, tables, files, databases, and web page files that are used for various kinds of processing and web sites.

It is possible to realize the server unit 100 by connecting peripheral units like a printer, a monitor, and an image scanner to an information processing unit like an information processing terminal such as personal computer, and a workstation that are known units. Further, software (including programs and data) which realizes the method of the present invention may be installed on this information processing unit.

A detailed structure of the scattering and integration of the server unit 100 is not limited to those shown in the drawings. It is also possible to scatter and integrate functionally or physically the whole or a part of the server unit 100 in optional units based on various loads. For example, it is possible to independently structure each database as an independent database unit. A part of the processing may be realized by using a CGI (common gateway interface).

It is possible to realize the client unit 200 by connecting peripheral units like a printer, a monitor, and an image scanner to an information processing unit like an information processing terminal such as a personal computer, a workstation, a home game unit, an Internet TV, a PHS unit, a portable terminal, a mobile communication terminal, and a PDA that are known units. Further, software (including programs and data) which realizes the web information browsing function and the electronic mail function may be installed on this information processing unit.

It is possible to realize the whole or a part of the control section of the client unit 200 based on a CPU or a program that is interpreted and executed by this CPU. In other words, a ROM or an HD is recorded with a computer program that gives instructions to the CPU to execute various kinds of operation, in cooperation with an OS (operating system). This computer program is loaded on the RAM and is executed. The computer program structures the control section in cooperation with the CPU.

This computer program may also be recorded in an application program server that is connected to the client unit 200 via an optional network. It is possible to download the whole or a part of this computer program according to the needs. It is also possible to realize the whole or an optional part of each control section as hardware according to a wired logic.

It is possible to store the program on a computer-readable recording medium. The “recording medium” includes an optional “portable physical medium” such as a floppy disk, an optical magnetic disk, a ROM, an EPROM, an EEPROM, a CD-ROM, an MO, and a DVD, an optional “fixed physical medium” such as a ROM, an RAM, and an HD that are incorporated in various computer systems, and a “communication medium” that holds the program during a short period of time such as a communication line and a carrier wave that transmit the program via a network as represented by a LAN, a WAN, and the Internet.

The “program” is a data processing method described in an optional language based on an optional description method. This may be in the format of a source code or a binary code. The “program” is not necessarily structured as a single unit, and includes a scattered structure like a plurality of modules and libraries. The “program” also includes those that cooperate with other programs as represented by an OS (operating system) to achieve their functions. It is possible to use known structures and procedures, for detailed structures to read the recording medium, reading procedures, and installation procedures after reading the recording medium in each unit of the embodiments.

The network 300 has a function of connecting the server unit 100 and the client unit 200 to each other. The network 300 may include any one of the Internet, an intranet, a LAN (including a wired and a radio), a VAN, a personal computer communication network, a public telephone network (including analog and digital), a private line network (including analog and digital), a CATV network, a portable line switching network/portable packet switching network of the IMT2000 system, the GSM system or the PDC/PDC-P system, a radio paging network, a local radio network like Bluetooth, a PHS network, and a satellite communication network like the CS, the BS, and the ISDB. In other words, the present system can transmit/receive various kinds of data via an optional network regardless of a wired or a radio.

As explained in detail above, according to the present invention, the system of the invention stores product information relevant to a product that an online shopping site sells. The system receives a recommendation request in which a first user recommends the desired product, and notifies a second user that the first user recommends the product to the second user, based on the received recommendation request. Therefore, a server unit can efficiently recommend a registered product to a user. Further, it is possible to provide a communication system, a communication information processing unit, an information terminal unit, a product recommendation method, and a program which can enable a user to receive kickback from the online shopping site when the user has purchased the product.

The user can efficiently transmit a product recommendation statement to many persons based on a simple operation, and an individual can easily work as an advertising medium, and also as an individual shop. Therefore, it is possible to provide a communication system, a communication information processing unit, an information terminal unit, a product recommendation method, and a program which can maximize the power of the individual.

Further, it is possible to provide a communication system, a communication information processing unit, an information terminal unit, a product recommendation method, and a program which can enable the online shopping site to efficiently advertise the own product to users of the communication system.

Further, according to the present invention, the communication information processing unit of the invention stores information on other users who have a predetermined relationship with the user. The second user is a user who has been registered as a person having a relationship with the first user. Therefore, when a user has a friend list that is provided by the communication system, the user can make recommendation to users who are on this list.

Further, according to the present invention, the product information includes product attribute information that is relevant to attributes of the product. The communication information processing unit stores user attribute information that is relevant to attributes of the user, and extracts the user who has the user attribute information relevant to the product attribute information of the product that has been recommended by the first user in the recommendation request. The second user is the user who has been extracted. Therefore, it is possible to extract users who are interested in the product, and make recommendation to these extracted users. Consequently, it is possible to transmit information to the users that is useful for them. Further, it is also possible to increase the product advertising efficiency.

Further, according to the present invention, the communication information processing unit of the invention enables users to individually transmit/receive real-time messages between them. The recommending unit uses the real-time message transmitting/receiving unit, to notify a message to the second user that the first user recommends the product. Therefore, it is possible to make recommendation to other users by using the real-time message of the communication system. Consequently, the user can easily make recommendation to other users. Further, it is also possible to increase the product advertising efficiency.

Further, according to the present invention, the communication information processing unit of the invention extracts a user who has exchanged real-time messages with the first user. The second user is the user who has been extracted. Therefore, it is possible to automatically make recommendation to users with whom real-time messages of the communication system have been exchanged in the past. Consequently, the user can easily make recommendation. Further, it is also possible to increase the product advertising efficiency.

Further, according to the present invention, the communication information processing unit of the invention enables the users to exchange electronic mails between them. The recommending unit uses the electronic mail transmitting/receiving unit, to notify the second user that the first user recommends the product to the second user. Therefore, it is possible to make recommendation to other users by using the electronic mails of the communication system. Consequently, the user can easily make recommendation to other users. Further, it is also possible to increase the product advertising efficiency.

Further, according to the present invention, the communication information processing unit of the invention extracts a user who has exchanged electronic mails with the first user. The second user is the user who has been extracted. Therefore, it is possible to automatically make recommendation to users with whom electronic mails have been exchanged in the past. Consequently, the user can easily make recommendation. Further, it is also possible to increase the product advertising efficiency.

Further, according to the present invention, the communication information processing unit of the invention provides the user with an online talking including an electronic bulletin board or charts. The recommending unit uses the online talking unit, to notify the second user that the first user recommends the product to the second user. Therefore, it is possible to make recommendation to other users by using the online talking of the communication system. Consequently, the user can easily make recommendation to other users. Further, it is also possible to increase the product advertising efficiency.

Further, according to the present invention, the communication information processing unit of the invention extracts a user who has carried out online talking with the first user. The second user is the user who has been extracted. Therefore, it is possible to automatically make recommendation to users with whom online talking of the communication system has been carried out in the past. Consequently, the user can easily make recommendation. Further, it is also possible to increase the product advertising efficiency.

Further, according to the present invention, the communication information processing unit of the invention adds information according to the online shopping in order to sell the product, to a note on the product information when there is this note on the product information while online talking is being carried out. Therefore, when the product information is written into the note while the online talking of the communication system is being carried out, it is possible to automatically set a link to the URL of the online shopping site, and, it becomes possible to automatically give relevant information. Consequently, the user can easily make recommendation. Further, it is also possible to increase the product advertising efficiency.

Further, according to the present invention, the communication information processing unit of the invention provides the user with a homepage for the user. The recommending unit uses the homepage proving unit, to notify the second user that the first user recommends the product to the second user. Therefore, it is possible to make recommendation to other users by using the homepage of the user in the communication system. Consequently, the user can easily make recommendation to other users. Further, it is also possible to increase the product advertising efficiency.

Further, according to the present invention, the communication information processing unit of the invention extracts a user who has accessed the homepage of the first user. The second user is the user who has been extracted. Therefore, it is possible to automatically make recommendation to users who have accessed the homepage of the user in the communication system in the past. Consequently, the user can easily make recommendation. Further, it is also possible to increase the product advertising efficiency.

Further, according to the present invention, the communication information processing unit of the invention can notify the information terminal unit of the second user about at least one of the information on the online shopping site which sells the product, the product information on the product that the first user recommends, and the information on the first user. Therefore, it is possible to send information that is necessary for the second user who receives the recommendation. Consequently, it is possible to recommend the product efficiently.

Further, according to the present invention, the communication information processing unit of the invention can notify the online shopping site that sells the product that the first user recommends the product to the information terminal unit of the second user. Therefore, the online shopping site can know instantly that the own product is being recommended.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

What is claimed is:

1. A communication system which uses a plurality of information terminal units that are connected to a communication information processing unit via a network, and in which users of said information terminal units communicate with each other,
said communication system comprising:
a product information storing unit which stores product information relevant to a product that an online shopping site sells;
a recommendation request receiving unit which receives a recommendation request in which a first user recommends said desired product; and
a recommending unit which notifies a second user that said first user recommends said product to said second user, based on the recommendation request that has been received by the recommendation request receiving unit.

2. A communication information processing unit which is connected to a plurality of information terminal units via a network, and which structures a communication system in which users of said information terminal units communicate with each other,
said communication information processing unit comprising:
a product information storing unit which stores product information relevant to a product that an online shopping site sells;
a recommendation request receiving unit which receives a recommendation request in which a first user recommends said desired product to a second user; and
a recommending unit which notifies said second user that said first user recommends said product to said second user, based on the recommendation request that has been received by the recommendation request receiving unit.

3. The communication information processing unit according to claim 2, said communication information processing unit further comprising:
a relevant-person storing unit which stores information on other users who have a predetermined relationship with said user, wherein
said second user is a user who has been registered in the relevant-person storing unit as a person having a relationship with said first user.

4. The communication information processing unit according to claim 2, wherein
the product information includes product attribute information that is relevant to attributes of said product,
said communication information processing unit further comprises:
a user attribute storing unit which stores user attribute information that is relevant to attributes of said user; and
a user extracting unit which extracts said user who has the user attribute information relevant to the product attribute information of said product that has been recommended by said first user in the recommendation request, wherein
said second user is said user who has been extracted by the user extracting unit.

5. The communication information processing unit according to claim 2, wherein
the user attribute information is at least one of user's information on gender, occupation, constellation, age, blood type, date of birth, hobby, special ability, address, resident area, interested genre, and signs of the zodiac.

6. The communication information processing unit according to claim 2, said communication information processing unit further comprising:
a real-time message transmitting/receiving unit which enables users to individually transmit/receive real-time messages between them, wherein
the recommending unit uses the real-time message transmitting/receiving unit, to notify said second user that said first user recommends said product to said second user.

7. The communication information processing unit according to claim 2, said communication information processing unit further comprising:
a real-time message transmitter/receiver extracting unit which extracts a user who has transmitted/received real-time messages to/from said first user, wherein
said second user is said user who has been extracted by the real-time message transmitter/receiver extracting unit.

8. The communication information processing unit according to claim 2, said communication information processing unit further comprising:
an electronic mail transmitting/receiving unit which transmits/receives electronic mails to/from said users, wherein
the recommending unit uses the electronic mail transmitting/receiving unit, to notify said second user that said first user recommends said product to said second user.

9. The communication information processing unit according to claim 2, further comprising:
an electronic mail transmitter/receiver extracting unit which extracts a user who has transmitted/received electronic mails to/from said first user, wherein
said second user is said user who has been extracted by the electronic mail transmitter/receiver extracting unit.

10. The communication information processing unit according to claim 2, further comprising:
an online talking unit which provides an online talking including an electronic bulletin board or charts, wherein
the recommending unit uses the online talking unit, to notify said second user that said first user recommends said product to said second user.

11. The communication information processing unit according to claim 2, further comprising:
an online talker extracting unit which extracts a user who has carried out online talking with said first user, wherein
said second user is said user who has been extracted by the online talker extracting unit.

12. The communication information processing unit according to claim 2, further comprising:
an online talking adding unit which adds information according to the online shopping in order to sell said product, to a note on the product information when there is this note on the product information while online talking is being carried out.

13. The communication information processing unit according to claim 2, further comprising:
a homepage proving unit which provides said user with a homepage for said user, wherein
the recommending unit uses the homepage proving unit, to notify said second user that said first user recommends said product to said second user.

14. The communication information processing unit according to claim 2, further comprising:
a homepage access person extracting unit which extracts a user who has accessed the homepage of said first user, wherein
said second user is said user who has been extracted by the homepage access person extracting unit.

15. The communication information processing unit according to claim 2, wherein
the recommending unit can notify said information terminal unit of said second user about at least one of the information on the online shopping site which sells said product, the product information on said product that said first user recommends, and the information on said first user.

16. The communication information processing unit according to claim 2, wherein
said communication information processing unit can notify the online shopping site which sells said product that said first user recommends said product to said information terminal unit of said second user.

17. An information terminal unit which is connected to a communication information processing unit via a network, and which structures a communication system in which users of information terminal units communicate with each other based on the control of said communication information processing unit,
said information terminal unit comprising:
a recommendation request transmitting unit which transmits to said communication information processing unit a recommendation request in which a first user recommends a second user a product that the online shopping site is selling.

18. The information terminal unit according to claim 17, further comprising:
a recommendation information receiving unit which receives the information about said first user recommending said product that has been transmitted from said communication information processing unit, based on the recommendation request that has been transmitted from the recommendation request transmitting unit; and
an output unit which outputs the information received by the recommendation information receiving unit.

19. The information terminal unit according to claim 17, further comprising:
a relevant-person storing unit which stores information on other users who have a predetermined relationship with said user, wherein
said second user is a user who has been registered in the relevant-person storing unit as a person having a relationship with said first user.

20. The information terminal unit according to claim 17, wherein
the product information includes product attribute information that is relevant to attributes of said product,
said information terminal unit further comprises:
a user attribute storing unit which stores user attribute information that is relevant to attributes of said user; and
a user extracting unit which extracts said user who has the user attribute information relevant to the product attribute information of said product that has been recommended by said first user in the recommendation request, wherein
said second user is said user who has been extracted by the user extracting unit.

21. The information terminal unit according to 17, wherein
the user attribute information is at least one of user's information on gender, occupation, constellation, age, blood type, date of birth, hobby, special ability, address, resident area, interested genre, interested products, and signs of the zodiac.

22. The information terminal unit according to claim 17, further comprising:
a real-time message transmitting/receiving unit which enables users to individually transmit/receive real-time messages between them, wherein
the recommending unit uses the real-time message transmitting/receiving unit, to notify said second user that said first user recommends said product to said second user.

23. The information terminal unit according to claim 17, further comprising:
a real-time message transmitter/receiver extracting unit which extracts a user who has transmitted/received real-time messages to/from said first user, wherein
said second user is said user who has been extracted by the real-time message transmitter/receiver extracting unit.

24. The information terminal unit according to claim 17, further comprising:
an electronic mail transmitting/receiving unit which transmits/receives electronic mails to/from said users, wherein
the recommending unit uses the electronic mail transmitting/receiving unit, to notify said second user that said first user recommends said product to said second user.

25. The information terminal unit according to claim 17, further comprising:
an electronic mail transmitter/receiver extracting unit which extracts a user who has transmitted/received electronic mails to/from said first user, wherein
said second user is said user who has been extracted by the electronic mail transmitter/receiver extracting unit.

26. The information terminal unit according to claim 17, further comprising:
an online talking unit which provides an online talking including an electronic bulletin board or charts, wherein
the recommending unit uses the online talking unit, to notify said second user that said first user recommends said product to said second user.

27. The information terminal unit according to claim 17, further comprising:
an online talker extracting unit which extracts a user who has carried out online talking with said first user, wherein
said second user is said user who has been extracted by the online talker extracting unit.

28. The information terminal unit according to claim 17, further comprising:
an online talking adding unit which adds information according to the online shopping in order to sell said product, to a note on the product information when there is this note on the product information while online talking is being carried out.

29. The information terminal unit according to claim 17, further comprising:
a homepage proving unit which provides said user with a homepage for said user, wherein
the recommending unit uses the homepage proving unit, to notify said second user that said first user recommends said product to said second user.

30. The information terminal unit according to claim 17, further comprising:
a homepage access person extracting unit which extracts a user who has accessed the homepage of said first user, wherein
said second user is said user who has been extracted by the homepage access person extracting unit.

31. The information terminal unit according to claim 17, wherein
the recommendation information receiving unit receives from said communication information processing unit at least one of the information on the online shopping site which sells said product, the product information on said product that said first user recommends, and the information on said first user.

32. The information terminal unit according to claim 17, further comprising:
a display screen information receiving unit which receives display screen information including a product purchasing button which purchases said product that said first user recommends, from said communication information processing unit, wherein
said second user purchases said product by selecting said product purchasing button that has been received by the display screen information receiving unit, via an input unit.

33. The information terminal unit according to claim 17, further comprising:
an access unit which makes access to the online shopping site that sells said product, based on the information received by the recommendation information receiving unit.

34. A product recommendation method which uses a communication information processing unit that is connected to a plurality of information terminal units via a network, and that structures a communication system in which users of said information terminal units communicate with each other,
the product recommendation method comprising:
a product information storing step which stores product information that is relevant to a product that an online shopping site sells;
a recommendation request receiving step which receives a recommendation request in which a first user recommends said desired product to a second user; and
a recommending step which notifies to said second user that said first user recommends said product to said second user, based on the recommendation request that has been received at the recommendation request receiving step.

35. The product recommendation method according to claim 34, further comprising:
a relevant-person storing step which stores information on other users who have a predetermined relationship with said user, wherein
said second user is a user who has been registered at the relevant-person storing step as a person having a relationship with said first user.

36. The product recommendation method according to claim 34, wherein
the product information includes product attribute information that is relevant to attributes of said product,
said product recommendation method further comprises:
a user attribute storing step which stores user attribute information that is relevant to attributes of said user; and
a user extracting step which extracts said user who has the user attribute information relevant to the product attribute information of said product that has been recommended by said first user in the recommendation request, wherein
said second user is said user who has been extracted at the user extracting step.

37. The product recommendation method according to claim 34, wherein
the user attribute information is at least one of user's information on gender, occupation, constellation, age, blood type, date of birth, hobby, special ability, address, resident area, interested genre, interested products, and signs of the zodiac.

38. The product recommendation method according to claim 34, further comprising:
a real-time message transmitting/receiving step which enables users to individually transmit/receive real-time messages between them, wherein
the recommending step uses the real-time message transmitting/receiving step, to notify said second user that said first user recommends said product to said second user.

39. The product recommendation method according to claim 34, further comprising:
a real-time message transmitter/receiver extracting step which extracts a user who has transmitted/received real-time messages to/from said first user, wherein
said second user is said user who has been extracted at the real-time message transmitter/receiver extracting step.

40. The product recommendation method according to claim 34, further comprising:
an electronic mail transmitting/receiving step which transmits/receives electronic mails to/from said users, wherein
the recommending step uses the electronic mail transmitting/receiving step, to notify said second user that said first user recommends said product to said second user.

41. The product recommendation method according to claim 34, further comprising:
an electronic mail transmitter/receiver extracting step which extracts a user who has transmitted/received electronic mails to/from said first user, wherein
said second user is said user who has been extracted at the electronic mail transmitter/receiver extracting step.

42. The product recommendation method according to claim 34, further comprising:
an online talking step which provides an online talking including an electronic bulletin board or charts, wherein
the recommending step uses the online talking step, to notify said second user that said first user recommends said product to said second user.

43. The product recommendation method according to claim 34, further comprising:
an online talker extracting step which extracts a user who has carried out online talking with said first user, wherein
said second user is said user who has been extracted at the online talker extracting step.

44. The product recommendation method according to claim 34, further comprising:
an online talking adding step which adds information according to the online shopping in order to sell said product, to a note on the product information when there is this note on the product information while online talking is being carried out.

45. The product recommendation method according to claim 34, further comprising:
a homepage proving step which provides said user with a homepage for said user, wherein
the recommending step uses the homepage proving step, to notify said second user that said first user recommends said product to said second user.

46. The product recommendation method according to claim 34, further comprising:
a homepage access person extracting step which extracts a user who has accessed the homepage of said first user, wherein
said second user is said user who has been extracted at the homepage access person extracting step.

47. The product recommendation method according to claim 34, wherein
at the recommending step, it is possible to notify the information terminal unit of said second user about at least one of the information on the online shopping site which sells said product, the product information on said product that said first user recommends, and the information on said first user.

48. The product recommendation method according to claim 34, wherein
it is possible to notify the online shopping site which sells said product that said first user recommends said product to said information terminal unit of said second user.

49. A computer program which makes a computer execute a product recommendation method which uses a communication information processing unit that is connected to a plurality of information terminal units via a network, and that structures a communication system in which users of said information terminal units communicate with each other,
the product recommendation method comprising:
a product information storing step which stores product information that is relevant to a product that an online shopping site sells;
a recommendation request receiving step which receives a recommendation request in which a first user recommends said desired product to a second user; and
a recommending step which notifies to said second user that said first user recommends said product to said second user, based on the recommendation request that has been received at the recommendation request receiving step.

50. The computer program according to claim 49, further comprising:
a relevant-person storing step which stores information on other users who have a predetermined relationship with said user, wherein
said second user is a user who has been registered at the relevant-person storing step as a person having a relationship with said first user.

51. The computer program according to claim 49, wherein
the product information includes product attribute information that is relevant to attributes of said product,
said product recommendation method further comprises:
a user attribute storing step which stores user attribute information that is relevant to attributes of said user; and
a user extracting step which extracts said user who has the user attribute information relevant to the product attribute information of said product that has been recommended by said first user in the recommendation request, wherein
said second user is said user who has been extracted at the user extracting step.

52. The computer program according to claim 49, wherein
the user attribute information is at least one of user's information on gender, occupation, constellation, age, blood type, date of birth, hobby, special ability, address, resident area, interested genre, interested products, and signs of the zodiac.

53. The computer program according to claim 49, further comprising:
a real-time message transmitting/receiving step which enables users to individually transmit/receive real-time messages between them, wherein
the recommending step uses the real-time message transmitting/receiving step, to notify said second user that said first user recommends said product to said second user.

54. The computer program according to claim 49, further comprising:
a real-time message transmitter/receiver extracting step which extracts a user who has transmitted/received real-time messages to/from said first user, wherein
said second user is said user who has been extracted at the real-time message transmitter/receiver extracting step.

55. The computer program according to claim 49, further comprising:
an electronic mail transmitting/receiving step which transmits/receives electronic mails to/from said users, wherein
the recommending step uses the electronic mail transmitting/receiving step, to notify said second user that said first user recommends said product to said second user.

56. The computer program according to claim 49, further comprising:
an electronic mail transmitter/receiver extracting step which extracts a user who has transmitted/received electronic mails to/from said first user, wherein
said second user is said user who has been extracted at the electronic mail transmitter/receiver extracting step.

57. The computer program according to claim 49, further comprising:
an online talking step which provides an online talking including an electronic bulletin board or charts, wherein
the recommending step uses the online talking step, to notify said second user that said first user recommends said product to said second user.

58. The computer program according to claim 49, further comprising:
an online talker extracting step which extracts a user who has carried out online talking with said first user, wherein
said second user is said user who has been extracted at the online talker extracting step.

59. The computer program according to claim 49, further comprising:
an online talking adding step which adds information according to the online shopping in order to sell said product, to a note on the product information when there is this note on the product information while online talking is being carried out.

60. The computer program according to claim 49, further comprising:
a homepage proving step which provides said user with a homepage for said user, wherein
the recommending step uses the homepage proving step, to notify said second user that said first user recommends said product to said second user.

61. The computer program according to claim 49, further comprising:
a homepage access person extracting step which extracts a user who has accessed the homepage of said first user, wherein
said second user is said user who has been extracted at the homepage access person extracting step.

62. The computer program according to claim 49, wherein
at the recommending step, it is possible to notify the information terminal unit of said second user about at least one of the information on the online shopping site which sells said product, the product information on said product that said first user recommends, and the information on said first user.

63. The computer program according to claim 49, wherein
it is possible to notify the online shopping site which sells said product that said first user recommends said product to said information terminal unit of said second user.
